(19) United States
(12) Patent Application Publication
(10) Pub. No.: US 2015/0215035 A1
(43) Pub. Date: Jul. 30, 2015

(54) OPTICAL LINE TERMINATION DEVICE, LINE PACKAGE, AND MONITOR PACKAGE

(71) Applicant: Haruki Idemaru, Chiyoda-ku (JP)

(72) Inventor: Haruki Idemaru, Chiyoda-ku (JP)

(73) Assignee: Mitsubishi Electric Corporation, Chiyoda-ku, Tokyo (JP)

(21) Appl. No.: 14/425,090

(22) PCT Filed: Nov. 14, 2012
(86) PCT No.: PCT/JP12/79501

§ 371 Date: Mar. 2, 2015

(51) Int. Cl. H04B 10/073

(52) U.S. Cl. CPC H04B 10/0731

(57) ABSTRACT

A line package includes: optical subscriber terminators that terminate optical lines; a line package internal line concentrator that concentrates lines; package first power supplies that output and stop power to the optical subscriber terminators; a line package internal controller that performs output control of the package first power supplies and performs opening settings of the line package internal line concentrator and the optical subscriber terminators in accordance with the monitor package; a package second power supply that outputs and stops power to the line package internal controller and the line package internal line concentrator in accordance with the monitor package; and a package third power supply that outputs and stops power to the line package as a whole and to the package first and second power supplies in accordance with the monitor package.

### TECHNICAL FIELD

The present disclosure relates to a method of reducing power consumption of an Optical Line Terminal (OLT) to be installed at a telecommunication carrier office in a passive optical network (PON) systems for use in providing, for example, a Fiber To The Home (FTTH) service.

### BACKGROUND ART

With the recent spread of the Internet and smart phones, the numbers of network lines and devices is on increase, and also power consumption is increasing. Shelf type OLTs installed at telecommunication carrier offices are designed in consideration of the future extensibility to allow packages to be increased in accordance with the state of use of the network lines. However, power is supplied regardless of usages of the packages after the packages are installed, which causes power consumption to be constant, leading to increase in power consumption of the devices.

As a method of reducing the power consumption, methods and devices to autonomously control the state of power supply are proposed, by which the amounts of usage, time, and state of lines are monitored in the packages (see, for example, Patent Literature 1).

### Patent Literature 1 JP-A-2007-097126

### SUMMARY OF INVENTION

With a network relay device as described in Patent Literature 1, a plurality of line interfaces is connectable to the same counter device, and communication (traffic) is maintained without disruption. Furthermore, influence from a stop of power supply can be reduced by, for example, selecting a line interface or detouring an unused line depending on the usage amount of the lines.

However, such as in, for example, a PON system, a device is needed to accommodate a plurality of users with one line and transmit/receive control frames for maintaining connection with optical network units (ONUs; optical line termination devices at subscriber side) to be installed at subscribers' premises. Since such the device is required not to stop power supply, it is difficult to employ the above-described method. Further, such the device is also needed to implement telephone services. However, since the usage state of the lines is unpredictable, the premise for application is greatly different in terms of difficulty in dynamic control. If power supply of a package containing an ONU is stopped, adverse effect is significant, since communication is disrupted at the local terminal or phone at the subscriber's premise.

With the larger capacity of OLTs and multiplicity of ports of line packages, many unused line packages and ports exist during a transition period, for example, before starting the service or right after introducing the service. Nonetheless, for the reasons described above, at OLTs of PON systems, a certain amount of power is consumed regardless of the status of service and usage state of the lines once the work is completed at the telecommunication carrier office and the state of implementation of packages is decided.

Meanwhile, methods for reducing power consumption may include a method that a mechanic person in charge of the work enters the office at which the OLT is installed to sequentially implement and/or remove the line package in the OLT for which the service has been started or terminated, according to the state of service deployment. In this case, however, the mechanic person is required to visit the office and work for each time, which takes much labor.

The present disclosure is made in view of the foregoing circumstances, in order to provide an optical line termination device, a line package, and a monitor package that allow, depending on an opening status of service after installing the line package, for supplying power only to functional blocks and ports in a line package to be used for the service.

An optical line termination device according to the present disclosure includes: a line package that terminates a plurality of optical lines; and a monitor package that controls the line package based on an instruction from an external terminal. The line package includes: a plurality of optical subscriber terminators that terminate the optical lines; a line package internal line concentrator that concentrates lines connected to the optical subscriber terminators; a first power supply that outputs and stops power to the optical subscriber terminators; a line package internal controller that performs, in accordance with an instruction from the monitor package, output control of the first power supply and opening settings of the line package internal line concentrator and the optical subscriber terminators; a second power supply that performs, in accordance with an instruction from the monitor package, output and stop of power to the line package internal controller and the line package internal line concentrator; and a third power supply that performs, in accordance with an instruction from the monitor package, output and stop of power to the line package as a whole, the first power supply, and the second power supply.

According to the present disclosure, because of the above-described configuration, work for starting the service is performed in such a manner as to be adjusted to the state of service supply and power supply of unused ports is controlled by an operator without touching the device by implementing and connecting a package, an optical fiber, and a LAN cable at the time of installing an OLT in the telecommunication carrier office according to a full service plan during a transition period, for example, before starting the service or right after introducing the service. Therefore, power consumption is reduced without adversely affecting communication performed by subscribers.

### BRIEF DESCRIPTION OF DRAWINGS

FIG. 1 is a block diagram depicting an overall configuration of an optical transmission system according to Embodiment 1 of the present invention.

FIG. 2 is a block diagram depicting a functional configuration in a line package according to the Embodiment 1 of the present invention.

FIG. 3 depicts a case in which a service is commenced only for one line in the line package according to the Embodiment 1 of the present invention.

FIG. 4 is a flowchart depicting a process at the time of starting the service of the line package to be performed through an operation terminal according to the Embodiment 1 of the present invention.

FIG. 5 depicts a case in which the service is not opened in the line package according to the Embodiment 1 of the present invention.

FIG. 6 depicts a case in which commencement of a service occurs with respect to one line in a line package according to Embodiment 2 of the present invention.

FIG. 7 is a flowchart depicting a process at the time of starting the service of a line package to be performed through a monitor package according to Embodiment 3 of the present invention.

FIG. 8 depicts a functional configuration in a case where the commencement of a service occurs with respect to one line in a line package according to Embodiment 4 of the present invention.

FIG. 9 is a flowchart depicting a process at the time of starting the service of the line package to be performed through a monitor package according to the Embodiment 4 of the present invention.

### DESCRIPTION OF EMBODIMENTS

Embodiments of the present invention are described in detail below with referring to the drawings.

### Embodiment 1

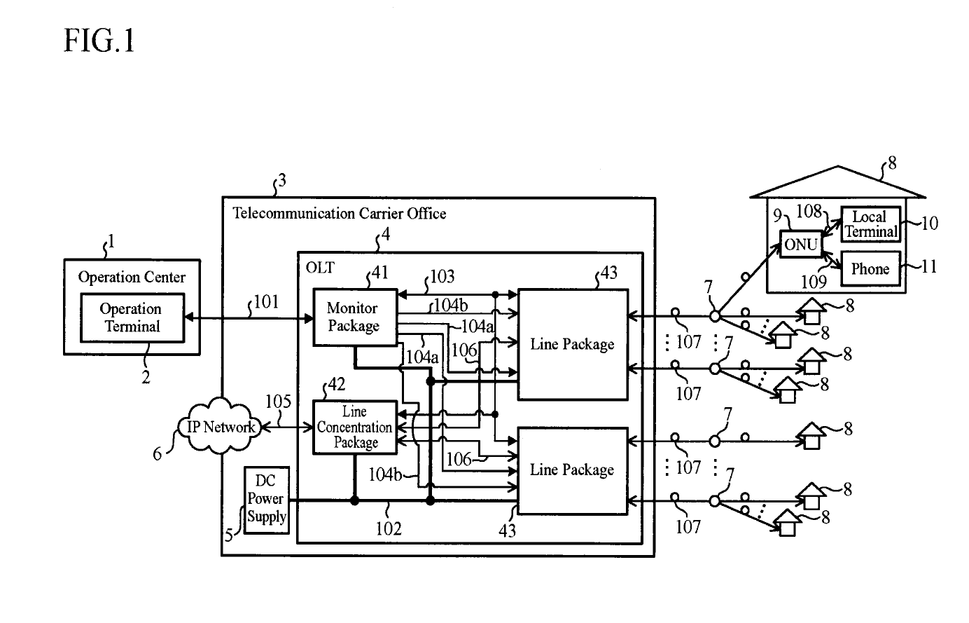

FIG. 1 is a block diagram depicting an overall configuration of an optical transmission system according to Embodiment 1 of the present invention.

The optical transmission system includes: an operation terminal 2 that is installed at an operation center 1; an OLT 4 and a DC power supply 5 that are installed at a telecommunication carrier office 3; an IP network 6; a plurality of optical couplers 7; and ONUs 9, local terminals 10 such as PCs, and phones 11 that are installed at a plurality of subscribers' premises 8.

The operation terminal 2 is configured to issue, through a device control line 101 to a monitor package 41 of the OLT 4, instructions of registering the ONUs 9 on a line concentration package 42 and line packages 43, opening settings, and output control of power supply.

The OLT 4 contains the monitor package 41, the line concentration package 42, and the line packages 43. The OLT 4 feeds power supplied from the DC power supply 5 through an OLT internal power supply line 102 to various types of packages 41-43.

The monitor package 41 is configured to perform opening settings of the line concentration package 42 and the line packages 43 through a package control line 103 in accordance with an instruction from the operation terminal 2 received through the device control line 101. The monitor package 41 also performs output control of power supply within the line packages 43 through line package power supply control lines 104a and 104b.

The line concentration package 42 is configured to concentrate inter-package lines 106 connected to the line packages 43 in the OLT 1. This line concentration package 42 performs transmission and reception of information with the IP network 6 through a network line 105 and also performs transmission and reception of information with the line packages 43 through the inter-package lines 106.

The line packages 43 are configured to terminate optical lines 107 connected to the ONUs 9. These line packages 43 perform transmission and reception of information with the line concentration package 42 through the inter-package lines 106 and also performs transmission and reception of information with the ONUs 9 through the optical lines 107.

The ONUs 9 are configured to perform transmission and reception of information with the line packages 43 through the optical lines 107, and also to perform transmission and reception of information with the local terminals 10 through LAN cables 108. The ONUs 9 are further configured to perform transmission and reception of information with the phones 11 through telephone lines 109.

The main configuration in the subscribers' premises 8 is an exemplary device configuration within a premise. It is also conceivable that a plurality of local terminals 10 are contained. Although FIG. 1 depicts the internal configuration of one subscriber's premise 8, other subscribers' premises 8 also have the same configuration.

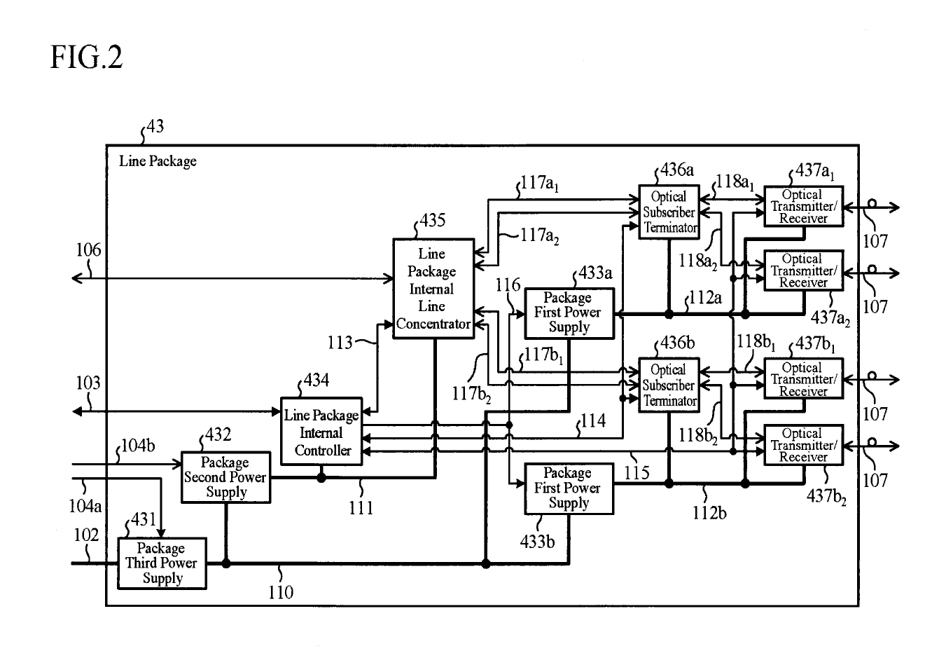

Description is given of a detailed configuration of the line packages 43 with referring to FIG. 2.

As depicted in FIG. 2, the line packages 43 each include: a package third power supply (a third power supply) 431; a package second power supply (a second power supply) 432; package first power supplies (first power supplies) 433a and 433b; a line package internal controller 434; a line package internal line concentrator 435; a plurality of optical subscriber terminators 436a and 436b; and a plurality of optical transmitters/receivers 437a_{1,} 437a_{2,} 437b₁ and 437b₂.

The package third power supply 431 is configured to, in accordance with an instruction from the monitor package 41 sent through the line package power supply control line 104a, output and stop power to the package second power supply 432 and the package first power supplies 433a and 433b through a board internal power supply line 110, where the power has been supplied from the DC power supply 5 through the OLT internal power supply line 102.

The package second power supply 432 is configured to, in accordance with an instruction from the monitor package 41 sent through the line package power supply control line 104b, output and stop power to the line package internal controller 434 and the line package internal line concentrator 435 through a board internal power supply line 111, where the power has been supplied from the package third power supply 431 through the board internal power supply line 110.

The package first power supply 433a is configured to, in accordance with an instruction from the line package internal controller 434 sent through a power supply control line 116, output and stop power to the optical subscriber terminator 436a and the optical transmitters/receivers 437a₁ and 437a₂ through a board internal power supply line 112a, where the power has been supplied from the package third power supply 431 through the board internal power supply line 110.

The package first power supply 433b is configured to, in accordance with an instruction from the line package internal controller 434 sent through the power supply control line 116, output and stop power to the optical subscriber terminator 436b and the optical transmitters/receivers 437b₁ and 437b₂ through a board internal power supply line 112b, where power is supplied from the package third power supply 431 through the board internal power supply line 110.

The line package internal controller 434 is configured to, in accordance with an instruction from the monitor package 41 sent through the package control line 103, control the line package internal line concentrator 435 through a line package internal line concentrator control line 113, control the optical subscriber terminators 436a and 436b through an optical subscriber terminator control line 114, and control the optical transmitters/receivers 437a_{1,} 437a_{2,} 437b₁ and 437b₂ through an optical transmitter/receiver control line 115. The line package internal controller 434 further controls the package first power supplies 433a and 433b through the power supply control line 116 and controls power supply to functional blocks in the board.

The line package internal line concentrator 435 is configured to concentrate user data signal lines 117a_{1,} 117a_{2,} 117b₁ and 117b₂ that are connected to the optical subscriber terminators 436a and 436b. This line package internal line concentrator 435 performs transmission and reception of information with the line concentration package 32 through the inter-package lines 106 and also performs transmission and reception of information with the optical subscriber terminators 436a and 436b through the user data signal lines 117a_{1,} 117a_{2,} 117b₁ and 117b₂.

The optical subscriber terminator 436a is configured to terminate the optical lines 107 which are connected to the ONUs 9 through the optical transmitters/receivers 437a₁ and 437a₂. The optical subscriber terminator 436a performs transmission and reception of information with the line package internal line concentrator 435 through the user data signal lines 117a₁ and 117a₂ and also performs transmission and reception of information with the optical transmitters/receivers 437a₁ and 437a₂ through user data signal lines 118a₁ and 118a₂.

The optical subscriber terminator 436b is configured to terminate the optical lines 107 that are connected to the ONUs 9 through the optical transmitters/receivers 437b₁ and 437b₂. This optical subscriber terminator 436b performs transmission and reception of information with the line package internal line concentrator 435 through the user data signal lines 117b₁ and 117b₂ and also performs transmission and reception of information with the optical transmitters/receivers 437b₁ and 437b₂ through the user data signal lines 118b₁ and 118b₂.

The optical transmitters/receivers 437a₁ and 437a₂ are configured to perform transmission and reception of information with the optical subscriber terminator 436a through the user data signal lines 117a₁ and 117a_{2,} and perform transmission and reception of information with the ONUs 9 through the optical lines 107.

The optical transmitters/receivers 437b₁ and 437b₂ are configured to perform transmission and reception of information with the optical subscriber terminator 436b through the user data signal lines 117b₁ and 117b_{2,} and perform transmission and reception of information with the ONUs 9 through the optical lines 107.

In the present embodiment, an example is described in which two line packages 43 are contained per OLT 4, two blocks of optical subscriber terminators 436 are contained per line package 43, and four optical lines 107 are contained, for the sake of convenience, however, the present invention is not restricted to this example.

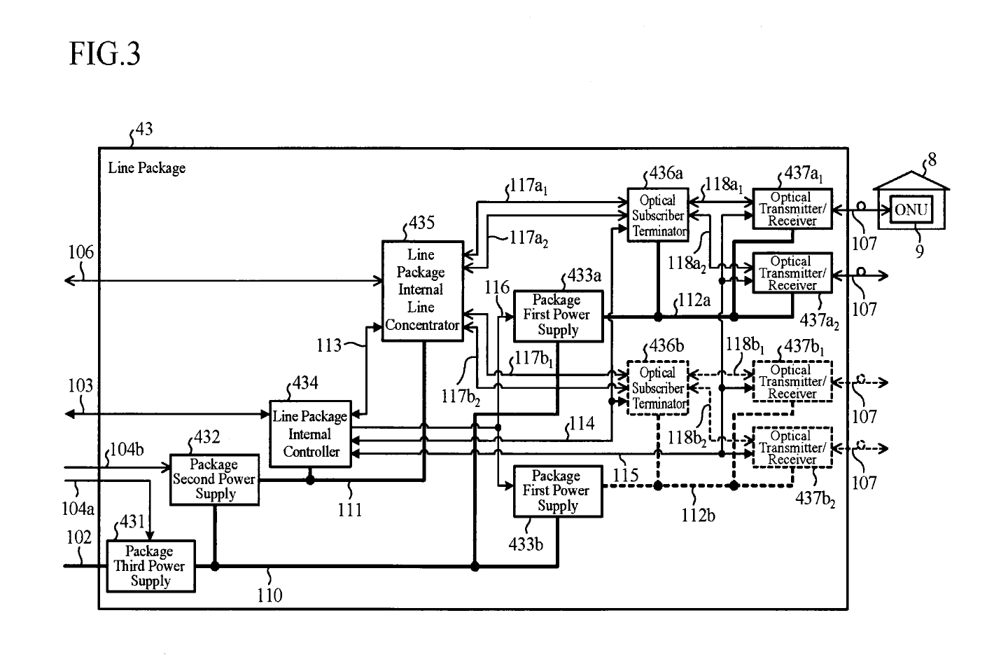

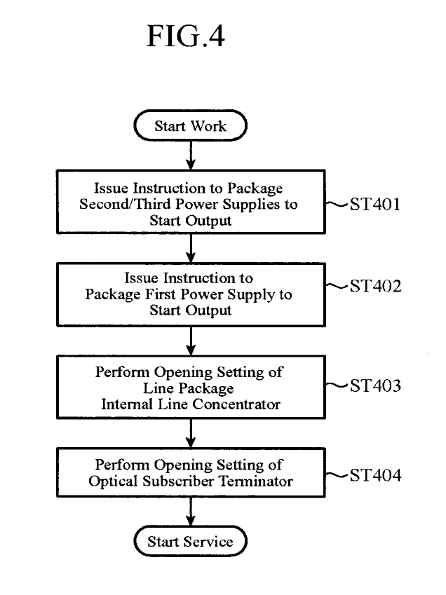

Next, description is given of an operation of the optical transmission system thus configured with referring to FIGS. 3 and 4.

As depicted in FIG. 3, in case where the service for a subscriber's premise 8 is started, the operation terminal 2 executes the work to open a line package 43 according to the flowchart in FIG. 4 through an operation of an operator by way of the monitor package 41. First, in order to activate the line package internal controller 434 and the line package internal line concentrator 435 in the line package 43, an instruction is issued to start outputs of the package third power supply 431 and the package second power supply 432 (Step ST401).

Subsequently, in order to activate the optical subscriber terminator 436a and the optical transmitter/receiver 437a_{1,} an instruction is issued to start output of the package first power supply 433a (Step ST402). At the same time, an instruction is issued to perform an opening setting of the line package internal line concentrator 435 (i.e. connection between the inter-package line 106 and the user data signal line 117a₁) (Step ST403).

Subsequently, an instruction is issued to perform an opening setting of the optical subscriber terminator 436a (i.e. opening of the optical line 107 and registration of the ONU 9, and setting of various types of parameters such as a transmission rate) (Step ST404.) In this case, since power is not supplied from the package first power supply 433b, power to be consumed by the functional blocks related to broken lines in FIG. 3 (i.e. the optical subscriber terminator 436b and the optical transmitters/receivers 437b₁ and 437b₂) can be cut.

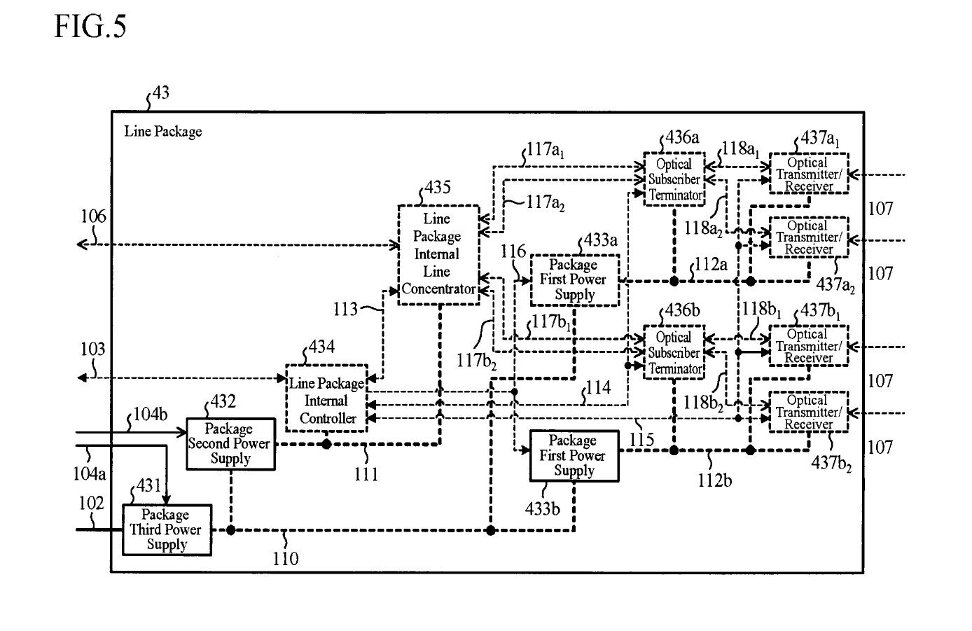

FIG. 5 represents a case where no service is started in the line package 43. In this case, output of the package third power supply 431 is stopped through the line package power supply control line 104a, and power supply to the functional blocks in the line package 43 is stopped. This allows for reduction of power supply to be consumed by the functional blocks related to the broken lines in FIG. 5 (i.e. the blocks except the package third power supply 431 in the line package 43).

As described above, according to the Embodiment 1, a plurality of power supplies 431, 432, 433a, and 433b, which are configured to switch power supply for individual functional blocks, are provided. Therefore, by implementing and connecting packages, optical fibers, and LAN cables according to a full service plan at the time of installing the OLT at the telecommunication carrier office during a transition period before the start of the service or right after the introduction of the service, an operator is enabled, without touching the device, to control a work for starting the service and power supply for unused ports according to the service state. This allows for reduction of power consumption without adversely affecting the communication to be performed at the subscriber.

### Embodiment 2

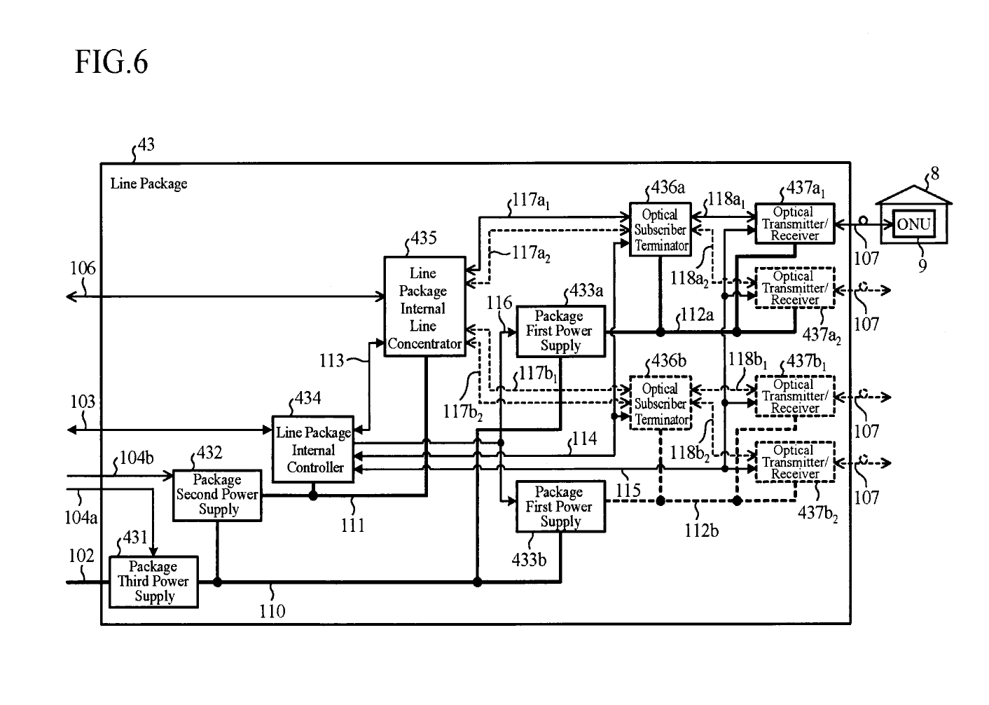

FIG. 6 depicts a case in which commencement of service occurs with respect to one line in a line package 43 according to Embodiment 2 of the present invention and depicts a state after a work for starting the service is performed. This line package 43 is configured in such a manner that functional blocks are subdivided in line unit in addition to the configuration of the Embodiment 1, and that blocks to be used are operated.

It is to be noted that the configuration of the line package 43 according to the Embodiment 2 depicted in FIG. 6 is the same as the line package 43 according to the Embodiment 1 depicted in FIG. 2. Thus, the same reference numerals are assigned, and the description thereof is omitted.

In the Embodiment 2, items for opening setting in Steps ST403 and ST404 of the flowchart in FIG. 4 are introduced.

In Step ST403, activation of the inter-package line 106 and the user data signal line 117a₁ is executed. After that, the same as in the Embodiment 1, the opening setting of the line package internal line concentrator 435 (i.e. connection between the inter-package line 106 and the user data signal line 117a₁) is performed. In Step ST404, activation of the user data signal line 117a₁ and the optical line 107 is executed. After that, the same as in the Embodiment 1, the opening setting of the optical subscriber terminator 436a (i.e. opening of the optical line 107) is performed.

In this case, power to be consumed by the functional blocks indicated with broken lines in FIG. 6 (in addition to FIG. 3, unused lines of the line package internal line concentrator 435 and the optical subscriber terminator 436a and optical transmitter/receiver 437a₂) can be cut.

As described above, according to the Embodiment 2, since the opening settings of the line package internal line concentrator 435 and the optical subscriber terminators 436a and 436b are performed on the line-by-line basis, power consumption can be reduced with a subdivision manner as compared with the Embodiment 1.

### Embodiment 3

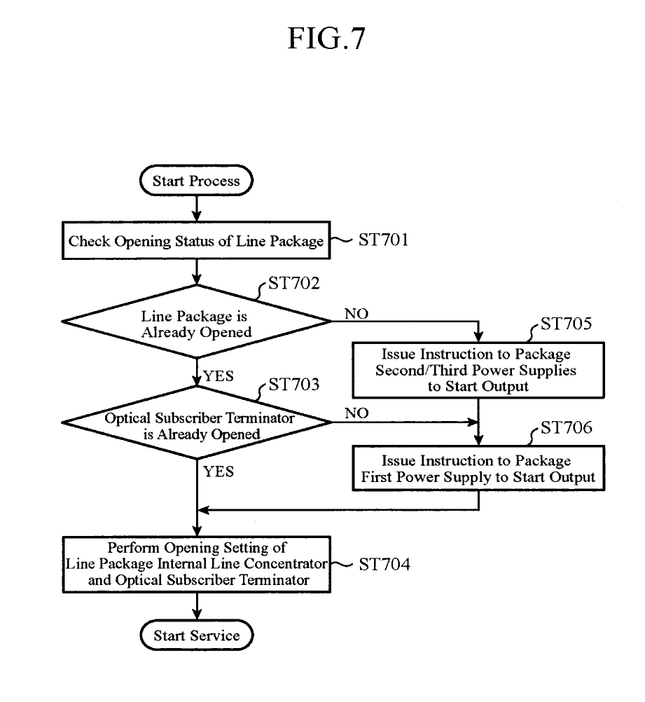

FIG. 7 is a flowchart depicting a process at the time of starting the service of a line package 43 to be performed through the monitor package 41 according to Embodiment 3 of the present invention. In the Embodiment 3, the setting of power supply, which is performed manually by an operator in the Embodiment 1, is performed automatically by the monitor package 41 depending on the status of service, and the setting of power supply by an operator is eliminated.

It is to be noted that the configuration of the line package 43 according to the Embodiment 3 is the same as that of the line package 43 according to the Embodiment 1 depicted in FIG. 2, and the description thereof is omitted.

An operator operates the operation terminal 2, when a request for starting the service is newly made at a subscriber's premise 8, to perform on the line package 43 the opening setting of the line package internal line concentrator 435 in Step ST403 and the opening setting of the optical subscriber terminator 436a in Step ST404 that are depicted in FIG. 4.

Meanwhile, the monitor package 41 performs the work for opening the service according to the flow depicted in FIG. 7 when an instruction to start the service (i.e. the opening settings of the line package internal line concentrator 435 and the optical subscriber terminator 436a) is received from the operation terminal 2. The status of service is checked based on the registration information of the ONU on the line package 43 (Step ST701), and the presence/absence of a line already in service in the line packages 43 is checked (Step ST702).

When it is confirmed that the service has already been opened in the Step ST702, the presence/absence of a line whose service has already been opened in the optical subscriber terminator 436a is checked (Step ST703).

Also in the Step ST703, the setting of power supply is not performed when it is confirmed that the service has already been opened. Thus, the opening settings of the line package internal line concentrator 435 and the optical subscriber terminator 436a are performed in accordance with an instruction to start the service from the operation terminal 2 (Step ST704).

Meanwhile, in Step ST702, when it is confirmed that the service in the line package 43 has not yet been opened, an instruction is issued to start the outputs of the package third power supply 431 and the package second power supply 432 (Step ST705), and an instruction is issued to start the output of the package first power supply 433a (Step ST706.) After that, the opening settings of the line package internal line concentrator 435 and the optical subscriber terminator 436a are performed (Step ST704).

Further, when it is confirmed that the service with respect to the optical subscriber terminator 436a has not yet been opened in Step ST703, an instruction is issued to start the output of the package first power supply 433a (Step ST706). After that, the opening settings of the line package internal line concentrator 435 and the optical subscriber terminator 436a are performed (Step ST704).

As described above, according to the Embodiment 3, it is checked at the monitor package 41 whether or not the services of the line package 43 and the optical subscriber terminator 436a have been opened before controlling the power supplies. Thus, the power to be consumed by functional units for which the service has not yet been started can be cut automatically without operation of an operator as compared with the Embodiment 1.

### Embodiment 4

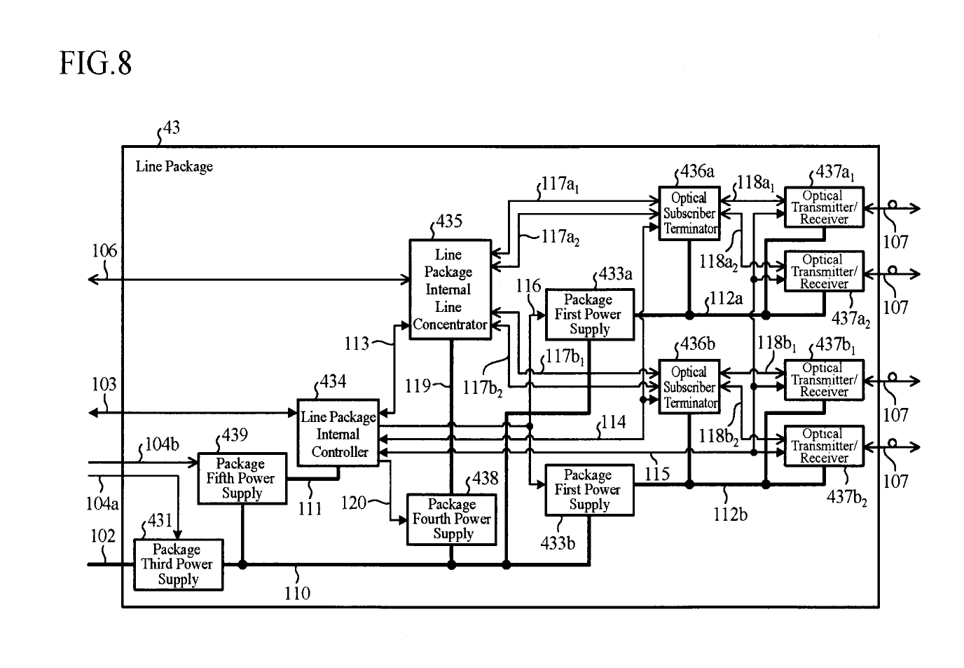

FIG. 8 is a block diagram depicting a functional configuration of a line package 43 according to Embodiment 4 of the present invention. The line package 43 according to the Embodiment 4 depicted in FIG. 8 is configured such that the package second power supply 432 is deleted from the line package 43 according to the Embodiment 1 depicted in FIG. 2, and that a package fourth power supply (fourth power supply) 438 for the line package internal line concentrator 435, a package fifth power supply (fifth power supply) 439 for the line package internal controller 434, a board internal power supply line 119, and a power supply control line 120 are added, so as to divide the package second power supply 432 into the package fourth power supply 438 and the package fifth power supply 439, and to individually control the power supplies. The other configuration is the same, and the same reference numerals are assigned, and the description is omitted.

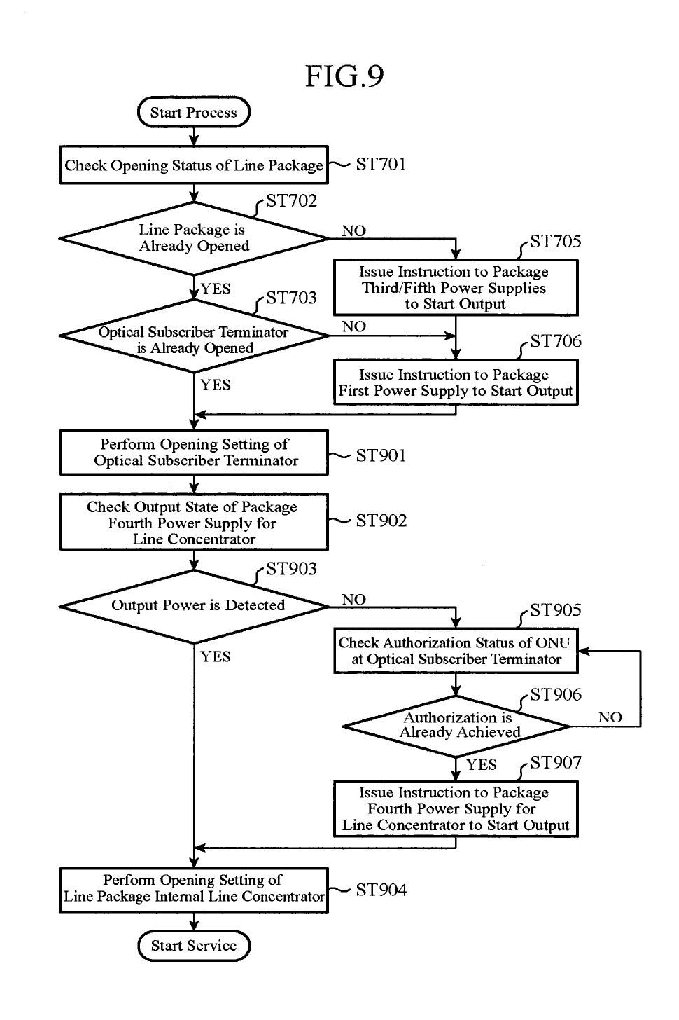

FIG. 9 is a flowchart depicting a process at the time of opening the service of the line package 43 to be performed through the monitor package 41 according to the Embodiment 4 of the present invention.

When an instruction to open the service is newly made at a subscriber's premise 8, an operator operates, the same as the Embodiment 3, the operation terminal 2 to perform on the line package 43 the opening setting of the line package internal line concentrator 435 in Step ST403 and the opening setting of the optical subscriber terminator 436a in Step ST404 that are depicted in FIG. 4.

Meanwhile, the monitor package 41 performs the work for opening the service according to the flow depicted in FIG. 9 when an instruction is received from the operation terminal 2 for opening the service (i.e. the opening settings of the line package internal line concentrator 435 and the optical subscriber terminator 436a). The service status is checked based on the registration information of the ONU on the line package 43 (Step ST701), and the presence/absence of a line already in service in the line packages 43 is checked (Step ST702).

When it is confirmed that the service has already been opened in this Step ST702, the presence/absence of a line already in service in the optical subscriber terminator 436a is checked (Step ST703).

When it is confirmed that the service has already been opened also in Step ST703, the opening setting of the optical subscriber terminator 436a is performed based on an instruction from the operation terminal 2 for starting the service (Step ST901), since power supply is already supplied to the optical subscriber terminator 436a and it is not needed that the package fourth power supply 433a is freshly enabled to output.

Subsequently, the output state of the package fourth power supply 438 is checked (Step ST902). When it is confirmed in this step ST 903 that the package fourth power supply 438 is in the output state (Step ST903), the opening setting of the line package internal line concentrator 435 is performed (Step ST904), since it is not needed that power is freshly output to the line package internal line concentrator 435.

On the other hand, when it is confirmed that the service has not yet been opened with respect to the line package 43 in Step ST702, an instruction is issued to start the output of the package third power supply 431 and the package fifth power supply 439 (Step ST705), and an instruction is issued to start the output of the package first power supply 433a (Step ST706). After that, the opening setting of the optical subscriber terminator 436a is performed (Step ST901).

When it is confirmed that the service has not yet been opened with respect to the optical subscriber terminator 436a in Step ST703, an instruction is issued to start the output of the package first power supply 433a (Step ST706). After that, the opening setting of the optical subscriber terminator 436a is performed (Step ST901).

When it is conformed that power is not output from the package fourth power supply 438 in Step ST903, authorization information of ONUs 9 in the optical subscriber terminator 436a is checked (Step ST905).

When it is confirmed in Step ST905 that there is an ONU 9 having been already authorized (Step ST906), an instruction is issued to start the output of the package fourth power supply 438 (Step ST907). After that, the opening setting of the line package internal line concentrator 435 is performed (Step ST904).

Meanwhile, when absence of an ONU 9 already authorized is confirmed in Step ST906, Steps ST905 and ST906 are repeated until authorization is achieved, and Step ST907 is performed upon confirmation of authorization.

As described above, according to the Embodiment 4, it is checked at the monitor package 41 for presence/absence of authorization of an ONU 9, and then power supply is controlled. Therefore, power supply to be consumed by the line package internal line concentrator 435 is automatically cut without the presence of an operator as compared with the Embodiment 1.

It is to be noted that the disclosure of the present application allows for free combination of embodiments or modification of any component of embodiments, or omission of any component in embodiments within the scope of the invention.

The optical line termination device, line package, and monitor package according to the present disclosure allows for selective power supply to functional blocks and ports in a line package to be used for service in accordance with the service status after the line package is implemented. For example, suitable application is available for, for example, optical line termination devices, line packages, and monitor packages to be installed at a telecommunication carrier office in a PON system for use in providing a service such as an FTTH service.

### REFERENCE SIGNS LIST

1 as Operation center; 2 as Operation terminal; 3 as Telecommunication carrier office; 4 as OLT; 5 as DC power supply; 6 as IP network; 7 as Optical coupler; 8 as Subscriber's premise; 9 as ONU; 10 as Local terminal; 11 as Phone; 41 as Monitor package; 42 as Line concentration package; 43 as Line package; 101 as Device control line; 102 as OLT internal power supply line; 103 as Package control line; 104a/104b as Line package power supply control line; 105 as Network line; 106 as Inter-package line; 107 as Optical line; 108 as LAN cable; 109 as Telephone line; 110/111/112a/112b/119 as Board internal power supply line; 113 as Line package internal line concentrator control line; 114 as Optical subscriber terminator control line; 115 as Optical transmitter/receiver control line; 116/120 as Power supply control line; 117a₁/117a₂/117b₁/117b₂/118a₁/118a₂/118b₁/118b₂ as User data signal line; 431 as Package third power supply (third power supply); 432 as Package second power supply (second power supply); 433a/433b as Package first power supply (first power supply); 434 as Line package internal controller; 435 as Line package internal line concentrator, 436a/436b as Optical subscriber terminator; 437a₁/437a₂/437b₁/437b₂ as Optical transmitter/receiver; 438 as Package fourth power supply (fourth power supply); 439 as Package fifth power supply (fifth power supply)

1. An optical line termination device comprising:
a line package that terminates a plurality of optical lines; and
a monitor package that controls the line package based on an instruction from an external terminal,
wherein the line package includes:
a plurality of optical subscriber terminators that terminate the optical lines;
a line package internal line concentrator that concentrates lines connected to the optical subscriber terminators;
a first power supply that outputs and stops power to the optical subscriber terminators;
a line package internal controller that performs, in accordance with an instruction from the monitor package, output control of the first power supply and opening settings of the line package internal line concentrator and the optical subscriber terminators;
a second power supply that performs, in accordance with an instruction from the monitor package, output and stop of power to the line package internal controller and the line package internal line concentrator; and
a third power supply that performs, in accordance with an instruction from the monitor package, output and stop of power to the line package as a whole, the first power supply, and the second power supply.

2. The optical line termination device according to claim 1, wherein the line package internal controller is configured to perform the opening settings of the line package internal line concentrator and the optical subscriber terminators on a line-by-line basis.

3. The optical line termination device according to claim 1, wherein the monitor package is configured to receive, from the external terminal, an instruction to perform output control of the first and second power supplies in the line package and an instruction to perform the opening settings of the line package internal line concentrator and the subscriber terminators.

4. The optical line termination device according to claim 1, wherein the monitor package is configured to determine necessity of the output control of the first and second power supplies in the line package by: receiving an instruction from the external terminal to perform the opening setting of the line package internal line concentrator and the optical subscriber terminators in the line package; and checking an opening status of the line package and the optical subscriber terminators.

5. The optical line termination device according to claim 1,
wherein the second power supply is replaced with: a fourth power supply that outputs and stops power to the line package internal line concentrator; and a fifth power supply that performs, in accordance with an instruction from the monitor package, output and stop of power to the line package internal controller,
wherein the line package internal controller is configured to perform, in accordance with an instruction from the monitor package, output control of the fourth power supply, and
wherein the monitor package is configured to determine necessity of the output control of the fourth power supply by checking an output state of the fourth power supply.

6. A line package that terminates a plurality of optical lines, the line package comprising:
a plurality of optical subscriber terminators that terminate the optical lines;
a line package internal line concentrator that concentrates lines connected to the optical subscriber terminators;
a first power supply that outputs and stops power to the optical subscriber terminators;
a line package internal controller that performs, in accordance with an instruction from outside, opening settings of the line package internal line concentrator and the optical subscriber terminators; and
a second power supply that performs, in accordance with an instruction from the outside, output and stop of power to the line package internal controller and the line package internal line concentrator.
wherein the line package internal controller performs output control of the first power supply in accordance with an opening status of the optical subscriber terminators.

7. A monitor package that controls a line package for terminating a plurality of optical lines, the line package including a plurality of optical subscriber terminators, a line package internal line concentrator, a first power supply, a line package internal controller, and a second power supply,
the optical subscriber terminators terminating the optical lines, the line package internal line concentrator concentrating lines connected to the optical subscriber terminators
the first power supply outputting and stopping power to the optical subscriber terminators, the monitor package being configured to:
receive from an external terminal an instruction to perform an opening setting, and instruct the line package internal controller to perform output control of the first power supply and opening settings of the line package internal line concentrator and the optical subscriber terminators; and
receive from an external terminal an instruction to perform output control, and instruct the second power supply to output and stop power to the line package internal controller and the line package internal line concentrator.

8. A monitor package that controls a line package for terminating a plurality of optical lines, the line package including a plurality of optical subscriber terminators, a line package internal line concentrator, a first power supply, a line package internal controller, and a second power supply, the optical subscriber terminators terminating the optical lines, the line package internal line concentrator concentrating lines connected to the optical subscriber terminators, the first power supply outputting and stopping power to the optical subscriber terminators, the line package internal controller performing output control of the first power supply and performing opening settings of the line package internal line concentrator and the optical subscriber terminators, the second power supply performing output and stop of power to the line package internal controller and the line package internal line concentrator, the monitor package is configured to determine necessity of output control of the first power supply and the second power supply,
wherein the determination on necessity of the output control of the first power supply and the second power supply is performed by:
receiving an instruction from the external terminal to perform opening settings of the optical subscriber terminators and the line package internal line concentrator; and
checking an opening status of the line package and the optical subscriber terminators.
